(19) United States
(12) Patent Application Publication
(10) Pub. No.: US 2015/0262731 A1
(43) Pub. Date: Sep. 17, 2015

(54) METHOD OF MAKING COPPER-CLAD GRAPHENE CONDUCTING WIRE

(71) Applicant: MERRY ELECTRONICS (SUZHOU) CO., LTD., Suzhou City (CN)

(72) Inventors: Mou-Tan LEE, Taichung City (TW); Tse-Yu LIU, Taichung City (TW); Zhi-Yuan LI, Taichung City (TW)

(73) Assignee: MERRY ELECTRONICS (SUZHOU) CO., LTD., SUZHOU CITY (CN)

(21) Appl. No.: 14/206,534

(22) Filed: Mar. 12, 2014

(51) Int. Cl. H01B 7/00; H01B 13/32; H01B 13/00

(52) U.S. Cl. CPC H01B 7/0009; H01B 13/0006; H01B 13/32

(57) ABSTRACT

A method of making a copper-clad graphene conducting wire is disclosed. By filling graphene paste into inside of a hollow copper tube and then stretching the copper tube, a copper-clad graphene conducting wire is made, thereby solving the technical problem that the copper-clad graphene conducting wire can hardly be manufactured.

### BACKGROUND OF THE INVENTION

1. Field of the Invention

The present invention relates generally to methods of making conducting wires and more particularly, to a method of making a copper-clad graphene conducting wire.

2. Description of the Related Art

Enameled wires have many types including pure copper wires, alloy wires and copper-coated aluminum wires. However, they have many disadvantages including high resistance, heavy weight and high frangibility and are easy to break. Commercially available graphene-clad copper conducting wires can improve the aforesaid disadvantages. However, because the graphene is disposed on the outmost layer, the graphene-clad conducting wires generally have a relatively larger diameter such that they cannot be applied in many fields, and the graphene-clad conducting wires have a difficulty in welding.

### SUMMARY OF THE INVENTION

The present invention has been accomplished under the circumstances in view. It is an objective of the present invention to provide a method of making a copper-clad graphene conducting wire, which is capable of encapsulating graphene inside a copper layer.

To attain the above-mentioned objective, the technical solution adopted by the present invention is to provide a method of making a copper-clad graphene conducting wire comprising the steps of:

a) filling a graphene paste into a hollow of a copper tube;

b) stretching step by step the copper tube for several times to form a conducting wire having a diameter of 0.001 mm to 1000 mm by a stretch forming process;

c) applying paint on the conducting wire and then baking the conducting wire; and

d) cooling and then receiving the conducting wire.

Preferably, the graphene paste may be a mixture of a graphene, a solvent, a resin and a surfactant.

Preferably, the step b) may be carried out by a diamond mold.

Preferably, in step b) the copper tube is stretched at an elongation rate (stretched diameter: initial diameter) less than 1.5 each time.

By means of the above-mentioned technical solution, the present invention has the following advantages compared to the prior art.

Because the present invention adopts the method of filling graphene paste into inside of copper tube and then stretching step by step the copper tube for several times to form a copper-clad graphene conducting wire, the technical problem that the copper-clad graphene conducting wire can hardly be manufactured is solved.

### BRIEF DESCRIPTION OF THE DRAWINGS

FIG. 1 is a schematic cross-sectional view of a copper-clad graphene conducting wire of the present invention.

### DETAILED DESCRIPTION OF EMBODIMENTS

The present invention will become more fully understood from the detailed description given herein below and the accompanying drawing showing an embodiment of the present invention.

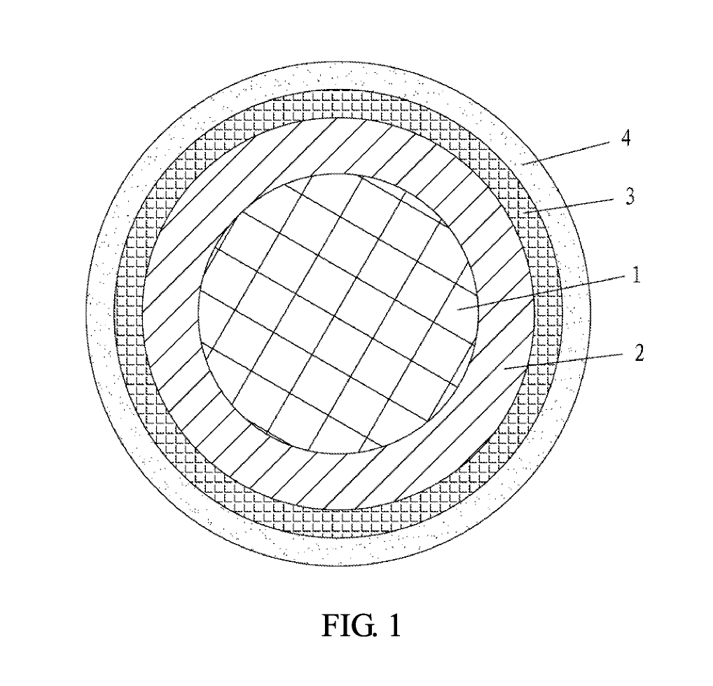

Referring to FIG. 1, a method of making a copper-clad graphene conducting wire according to an embodiment of the present invention comprises the following steps.

a) Fill a graphene paste into a hollow of a copper tube.

b) Stretch step by step the copper tube for several times to form a conducting wire having a diameter of 0.001 mm by a stretch forming process using a diamond mold, wherein the copper tube is stretched at an elongation rate (stretched diameter: initial diameter) of 1.2 each time.

c) Apply insulated paint on the conducting wire and then dry the insulated paint by baking. Repeatedly perform the aforesaid step for several times so as to form an insulated layer on an outer circumference of the conducting wire. Thereafter, a self-adhesive paint is applied on the conducting wire to form a self-adhesive layer.

d) Cool and then receive the conducting wire.

The copper-clad graphene conducting wire is composed of a graphene wire core 1, a copper layer 2, an insulated layer 3, and a self-adhesive layer 4 orderly arranged from inside toward outside of the conducting wire, as shown in FIG. 1.

In this embodiment, the graphene paste is a paste mixture of graphene (powder), a solvent, a resin and a surfactant.

Because the embodiment of the present invention adopts the method of filling graphene paste into inside of copper tube and then stretching step by step the copper tube for several times to form a copper-clad graphene conducting wire, the technical problem that the copper-clad graphene conducting wire can hardly be manufactured is solved.

It should be understood that the detailed description and specific example, while indicating preferred embodiment of the invention, are given by way of illustration only, and thus are not limitative of the present invention. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of making a copper-clad graphene conducting wire comprising the steps of:
a) filling a graphene paste into a hollow of a copper tube;
b) stretching step by step the copper tube for several times to form a conducting wire having a diameter of 0.001 mm to 1000 mm by a stretch forming process;
c) applying paint on the conducting wire and then baking the conducting wire; and
d) cooling the conducting wire and then receiving the conducting wire.

2. The method as claimed in claim 1, wherein the graphene paste is a mixture of graphene, a solvent, a resin and a surfactant.

3. The method as claimed in claim 1, wherein the step b) is carried out by a diamond mold.

4. The method as claimed in claim 1, wherein in the step b) the copper tube is stretched at an elongation rate less than 1.5 each time.

5. A copper-clad graphene conducting wire made by the method claimed in claim 1.
